(19) United States
(12) Patent Application Publication
(10) Pub. No.: US 2020/0332107 A1
(43) Pub. Date: Oct. 22, 2020

(54) FLUOROPOLYMER COMPOSITIONS INCLUDING FUNCTIONAL FLUORINATED SILANE COMPOUNDS

(71) Applicant: 3M INNOVATIVE PROPERTIES COMPANY, St. Paul, MN (US)

(72) Inventors: Michael H. Mitchell, Woodbury, MN (US); Miguel A. Guerra, Woodbury, MN (US)

(21) Appl. No.: 16/957,981

(22) PCT Filed: Dec. 20, 2018
(86) PCT No.: PCT/US2018/066661

§ 371 Date: Jun. 25, 2020

Related U.S. Application Data
(60) Provisional application No. 62/611,129, filed on Dec. 28, 2017.

(51) Int. Cl. C08L 27/18; C08L 27/16; C08L 33/16; C08L 23/12; C08L 53/00; C08K 5/54; C08K 5/5475; C08K 5/3492; C08K 5/14

(52) U.S. Cl. CPC C08L 27/18; C08L 27/16; C08L 33/16; C08L 23/12; C08L 53/00; C08L 2203/18; C08K 5/5475; C08K 5/34924; C08K 5/14; C08L 2201/08; C08K 5/5406

(57) ABSTRACT

Curable compositions that include at least one fluorinated elastomeric gum; and at least one compound according to formula I: X—(CF₂)ₙ—(O)ₚ—(CH₂)ₘ—Si—Y₃ (I) wherein X is Br, I, CF₂═CF—O—, CH₂═CHCH₂—O—, CH₂═CH—, or CH₂═CHCH₂—, n is an integer from 2 to 8, m is an integer from 2 to 5, p is 0 or 1, and Y is Cl— or —OR, where R is a linear or branched alkyl having 1 to 4 carbon atoms. In some embodiments, Y is —O(CH₂)ₓCH₃, where x is an integer from 0 to 3.

### TECHNICAL FIELD

The present disclosure relates to compositions that include functional fluorinated silane compounds and a fluorinated elastomeric gum, e.g., peroxide cure fluoropolymers.

### BACKGROUND

Elastomers that perform adequately at higher temperatures, for example, temperatures of 200° C. to 330° C. are of interest. Because of the higher bond energy of the C—F bond, perfluoroelastomers (fully fluorinated molecules) traditionally have been used at these extreme temperature conditions. However, the cost of perfluoroelastomers can make them undesirable or prohibitive for certain applications and markets. Partially fluorinated elastomers are typically less expensive than perfluorinated elastomers and because they comprise some fluorine, they can perform adequately in some of the same extreme conditions as the perfluorinated elastomers, e.g., chemical resistance, etc. However, they still do not always have acceptable physical properties for all applications.

### SUMMARY

A curable composition comprising: a fluorinated elastomeric gum; and at least one compound according to formula I:

X—(CF₂)ₙ—(O)ₚ—(CH₂)ₘ—Si—Y₃ (I)

wherein X is Br, I, CF₂═CF—O—, CH₂═CHCH₂—O—, CH₂═CH—, or CH₂═CHCH₂-, n is an integer from 2 to 8, m is an integer from 2 to 5, p is 0 or 1, and Y is Cl— or —OR, where R is a linear or branched alkyl having 1 to 4 carbon atoms. In some embodiments, Y is —O(CH₂)ₓCH₃, where x is an integer from 0 to 3.

Cured compositions and articles including cured compositions are also disclosed herein.

The above summary is not intended to describe each embodiment of the present disclosure. The details of one or more embodiments of the present disclosure are also set forth in the description below. Other features, objects, and advantages of the present disclosure will be apparent from the description and from the claims.

### DETAILED DESCRIPTION

“backbone” refers to the main continuous chain of a polymer;

“block copolymers” are polymers in which chemically different blocks or sequences are covalently bonded to each other.

“copolymer” refers to a polymeric material comprising at least two different interpolymerized monomers (i.e., the monomers do not have the same chemical structure) and include terpolymers (three different monomers), tetrapolymers (four different monomers), etc.;

“crosslinking” refers to connecting two pre-formed polymer chains using chemical bonds or chemical groups and can be used interchangeably with “curing”;

“cure site” refers to functional groups, which may participate in crosslinking;

“glass transition temperature” or “T_{g}” refers to the temperature at which a polymeric material transitions from a glassy state to a rubbery state. The glassy state is typically associated with a material that is, for example, brittle, stiff, rigid, or combinations thereof. In contrast, the rubbery state is typically associated with a material that is, for example, flexible and elastomeric.

“perfluorinated” means a group or a compound derived from a hydrocarbon wherein all hydrogen atoms have been replaced by fluorine atoms. A perfluorinated compound may however still contain other atoms than fluorine and carbon atoms, like chlorine atoms, bromine atoms and iodine atoms.

The present disclosure relates to a composition that includes at least a functional fluorinated silane compound and a fluorinated elastomeric gum. Disclosed compositions can be referred to as curable compositions.

Functional Fluorinated Silane Compounds

Disclosed fluorinated silane compounds include those of formula I below.

X—(CF₂)ₙ—(O)ₚ—(CH₂)ₘ—Si—Y₃ (I)

where X can be selected from Br, I, CF₂═CF—O—, CH₂═CHCH₂—O—, CH₂═CH—, or CH₂═CHCH₂—; n can be an integer from 2 to 8; m can be an integer from 2 to 5; p is 0 or 1; and Y is Cl— or —OR, where R is a linear or branched alkyl having 1 to 4 carbon atoms. In some embodiments, Y is —O(CH₂)ₓCH₃, where x is an integer from 0 to 3. In some embodiments, X can be CH₂═CHCH₂— or CH₂═CH—. In some embodiments, n can be an integer from 2 to 7, from 2 to 6 or even from 2 to 4. In some embodiments, m can be an integer from 2 to 4 or from 2 to 3. In some embodiments, Y can be —O(CH₂)ₓCH₃ where x is 0, i.e., Y is —OCH₃.

Illustrative specific fluorinated silane compounds disclosed and/or useful herein can include:
Br—C₂F₄—CH₂CH₂—SiCl₃ (BTFETCS),
Br—C₂F₄—CH₂CH₂—Si(OCH₃)₃ (BTFETMS),
CF₂═CF—O—C₄F₈—CH₂CH₂—SiCl₃ (MV4ETCS),
CF₂═CF—O—C₄F₈—CH₂CH₂—Si(OCH₃)₃ (MV4ETMS),
CF₂═CF—O—C₄F₈—CH₂CH₂CH₂—SiCl₃ (MV4PTCS),
CF₂═CF—O—C₄F₈—CH₂CH₂CH₂—Si(OCH₃)₃ (MV4PTMS),
CH₂═CHCH₂C₄F₈CH₂CH₂CH₂SiCl₃ (AC4PTCS),
CH₂═CHCH₂C₄F₈CH₂CH₂CH₂Si(OCH₃)₃ (AC4PTMS),
CH₂═CHCH₂—O—C₄F₈—O—CH₂CH₂CH₂SiCl₃ (AEC4EPTCS),
CH₂═CHCH₂—O—C₄F₈—O—CH₂CH₂CH₂Si(OCH₃)₃ (AEC4EPTMS),
CH₂═CHC₄F₈CH₂CH₂SiCl₃ (VC4ETCS), and
CH₂═CHC₄F₈CH₂CH₂Si(OCH₃)₃ (VC4ETMS).
   Other exemplary compounds include trialkoxy silane analogues of such trimethoxy silanes, e.g., triethoxy silanes.

In some embodiments, one method of making useful functional fluorinated silane compounds includes bonding a compound having a functional end with fluorinated carbons followed by an alkene on the opposite end that has been hydrosilylated with trichlorosilane using a platinum catalyst. This synthetic method is illustrated by the generic Scheme 1 below.

X—(CF₂)ₙ—(O)ₚ—(CH₂)ₘ—CH═CH₂+HSiCl₃(Pt)→X—(CF₂)ₙ—(O)ₚ—(CH₂)ₘ—Si—Cl₃ Scheme 1

In Scheme 1, X can be selected from Br, I, CF₂═CF—O—, CH₂═CHCH₂—O—, CH₂═CH—, or CH₂═CHCH₂—; n can be an integer from 2 to 8; m can be an integer from 2 to 5; p is 0 or 1; and Y can be Cl— or —OR, where R is a linear or branched alkyl having 1 to 4 carbon atoms. In some embodiments, Y can be —O(CH₂)ₓCH₃, where xis an integer from 0 to 3. Scheme 2 presents a more specific illustration of this particular synthetic method, wherein p=0.

X—(CF₂)ₙ—(CH₂)ₘ—CH═CH₂+HSiCl₃ (Pt)→X—(CF₂)ₙ—(CH₂)ₘ—Si—Cl₃ Scheme 2

In some methods, the trichlorosilane compounds can be reacted with an alcohol to produce easier to handle trialkoxy silanes. This synthetic method is illustrated by the generic Scheme 3 below using a linear alcohol as an exemplary alcohol.

X—(CF₂)ₙ—(O)ₚ—(CH₂)ₘ—Si—Cl₃+HO(CH₂)ₓCH₃→X—(CF₂)ₙ—(O)ₚ—(CH₂)ₘ—Si—(O(CH₂)ₓCH₃)₃ Scheme 3

In Scheme 3, X, m, n, and p are as defined above. Scheme 4 presents a more specific illustration of this particular synthetic method, wherein p=0.

X—(CF₂)ₙ—(CH₂)ₘ—Si—Cl₃+HO(CH₂)ₓCH₃→X—(CF₂)ₙ—(CH₂)ₘ—Si—(O(CH₂)ₓCH₃)₃ Scheme 4

In some embodiments, disclosed compositions include not less than 0.5 weight percent (wt %), not less than 1 wt %, or not less than 1.5 wt % of the functional fluorinated silane compound based on the total weight of the fluorinated elastomeric gum and functional fluorinated silane compound. In some embodiments, disclosed compositions include not greater than 20 wt %, not greater than 15 wt %, not greater than 10 wt %, or not greater than 5 wt % of the functional fluorinated silane compound based on the total weight of the fluorinated elastomeric gum and functional fluorinated silane compound. In some embodiments, a disclosed composition includes from about 1.5 wt % to about 5 wt %, and in some embodiments about 2 wt % of the functional fluorinated silane compound based on the total weight of the fluorinated elastomeric gum and functional fluorinated silane compound.

Fluorinated Elastomeric Gum

Disclosed compositions also include at least one fluorinated elastomeric gum. As used herein the phrase “fluorinated elastomeric gum” refers to a fluoropolymer that can be processed as a traditional elastomer. To be processed as a traditional elastomer means that the fluoropolymer that can be processed with a two-roll mill, an internal mixer, or a combination thereof. Mill blending, via a two-roll mill for example, is a process that rubber manufacturers use to combine a polymer gum with curing agents and/or additives. In order to be mill blended, the fluorinated elastomeric gum must have a sufficient modulus. In other words, the gum cannot be so soft that it sticks to the mill, but also not so stiff that it cannot be banded onto the mill. In some embodiments, useful fluorinated elastomeric gums can have a modulus of at least 0.1, at least 0.3, or even at least 0.5 MPa (megaPascals); and not greater than 2.5, not greater than 2.2, or not greater than 2.0 MPa at 100° C. as measured at a strain of 1% and a frequency of 1 Hz (Hertz), for example.

Useful fluorinated elastomeric gums may be perfluorinated or partially fluorinated. As disclosed herein, in a perfluorinated polymer, the carbon-hydrogen bonds along the backbone of the polymer are all replaced with carbon-fluorine bonds and optionally some carbon-chlorine bonds. It is noted that the backbone of the polymer excludes the sites of initiation and termination of the polymer. As disclosed herein, in a partially fluorinated polymer, the polymer comprises at least one carbon-hydrogen bond and at least one carbon-fluorine bond on the backbone of the polymer excluding the sites of initiation and termination of the polymer. In some embodiments, useful fluorinated elastomeric gums can be highly fluorinated, wherein at least 50, 60, 70, 80, or even 85% of the polymer backbone comprises C—F bonds and at most 90, 95, or even 99% of the polymer backbone comprises C—F bonds.

In some embodiments, useful fluorinated elastomeric gums may be derived from one or more fluorinated monomer(s) such as tetrafluoroethylene (TFE), vinyl fluoride (VF), vinylidene fluoride (VDF), hexafluoropropylene (HFP), pentafluoropropylene, trifluoroethylene, trifluorochloroethylene (CTFE), perfluorovinyl ethers, perfluoroallyl ethers, or combinations thereof

In some embodiments, perfluorovinyl ethers that can be useful as fluorinated elastomeric gums can be of Formula II:

CF₂═CFO(R_{f1}O)ₘR_{f2} (II)

where R_{f1} is a linear or branched perfluoroalkylene radical groups comprising 2, 3, 4, 5, or 6 carbon atoms, m is an integer selected from 0, 1, 2, 3, 4, 5, 6, 7, 8, 9, and 10, and R_{f2} is a perfluoroalkyl group comprising 1, 2, 3, 4, 5, or 6 carbon atoms. Illustrative specific perfluorovinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, and combinations thereof.

In some embodiments, perfluoroallyl ethers that can be useful as fluorinated elastomeric gums can be of Formula III

CF₂═CFCF₂O(R_{f1}O)ₙ(R_{f1}O)ₘ—R_{f2} (III)

where each R_{f1} is independently a linear or branched perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f2} is a perfluoroalkyl group comprising 1, 2, 3, 4, 5, or 6 carbon atoms. Illustrative specific perfluoroallyl ether monomers include: perfluoro(ethyl allyl)ether, perfluoro(n-propyl allyl)ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof

As is known by those of skill in the art, the fluorinated elastomeric gums can optionally be modified during formation thereof by the addition of small amounts of other copolymerizable monomers, which may or may not contain fluorine substitution, e.g. ethylene, propylene, butylene and the like. Use of these additional monomers (which can also be referred to as comonomers) is within the scope of the present disclosure. When present, these additional monomers can be used in amounts of not greater than 25 mole percent of the fluorinated elastomeric gum, in some embodiments less than 10 mole percent of the fluorinated elastomeric gum, and even less than 3 mole percent of the fluorinated elastomeric gum.

In some embodiments, the fluorinated elastomeric gum can be a random copolymer, which is amorphous, meaning that there is an absence of long-range order (in long-range order the arrangement and orientation of the macromolecules beyond their nearest neighbors is understood). An amorphous fluoropolymer has no detectable crystalline character by DSC (differential scanning calorimetry), meaning that if studied under DSC, the fluorinated elastomeric gum would not have a melting point or would have melt transitions with an enthalpy more than 0.002, 0.01, 0.1, or even 1 Joule/g from the second heat of a heat/cool/heat cycle, when tested using a DSC thermogram with a first heat cycle starting at −85° C. and ramped at 10° C./min to 350° C., cooling to −85° C. at a rate of 10° C./min and a second heat cycle starting from −85° C. and ramped at 10° C./min to 350° C. Illustrative specific amorphous random copolymers may include: copolymers comprising TFE and perfluorinated vinyl ethers monomeric units (such as copolymers comprising TFE and PMVE, and copolymers comprising TFE and PEVE); copolymers comprising TFE and perfluorinated allyl ethers monomeric units; copolymers comprising TFE and propylene monomeric units; copolymers comprising TFE, propylene, and VDF monomeric units; copolymers comprising VDF and HFP monomeric units; copolymers comprising TFE, VDF, and HFP monomeric units; copolymers comprising TFE and ethyl vinyl ether (EVE) monomeric units; copolymers comprising TFE and butyl vinyl ether (BVE) monomeric units; copolymers comprising TFE, EVE, and BVE monomeric units; copolymers comprising VDF and perfluorinated vinyl ethers monomeric units (such as copolymers comprising VDF and CF₂═CFOC₃F₇) monomeric units; an ethylene and HFP monomeric units; copolymers comprising CTFE and VDF monomeric units; copolymers comprising TFE and VDF monomeric units; copolymers comprising TFE, VDF and perfluorinated vinyl ethers monomeric units (such as copolymers comprising TFE, VDF, and PMVE) monomeric units; copolymers comprising VDF, TFE, and propylene monomeric units; copolymers comprising TFE, VDF, PMVE, and ethylene monomeric units; copolymers comprising TFE, VDF, and perfluorinated vinyl ethers monomeric units (such as copolymers comprising TFE, VDF, and CF₂═CFO(CF₂)₃OCF₃) monomeric units; and combinations thereof. In some embodiments, the fluorinated elastomeric gum is not a copolymer comprising VDF and HFP monomeric units.

In some embodiments, the fluorinated elastomeric gum can be a block copolymer in which chemically different blocks or sequences are covalently bonded to each other, wherein the blocks have different chemical compositions and/or different glass transition temperatures. In some embodiments, the block copolymer comprises a first block, A block, which is a semi-crystalline segment. If studied under a differential scanning calorimetry (DSC), this block would have at least one melting point temperature (Tₘ) of greater than 70° C. and a measurable enthalpy, for example, greater than 0 J/g (Joules/gram). The second block, or B block, is an amorphous segment, meaning that there is an absence of long-range order (i.e., in long-range order the arrangement and orientation of the macromolecules beyond their nearest neighbors is understood). The amorphous segment has no detectable crystalline character by DSC. If studied under DSC, the B block would have no melting point or melt transitions with an enthalpy more than 2 milliJoules/g by DSC. In some embodiments, the A block is a copolymer derived from at least the following monomers: tetrafluoroethylene (TFE), hexafluoropropylene (HFP), and vinylidene fluoride (VDF). In one embodiment, the A block comprises 30-85 wt (weight) % TFE; 5-40 wt % HFP; and 5-55 wt % VDF; 30-75 wt % TFE; 5-35 wt % HFP; and 5-50 wt % VDF; or even 40-70 wt % TFE; 10-30 wt % HFP; and 10-45 wt % VDF. In some embodiments, the B block is a copolymer derived from at least the following monomers: hexafluoropropylene (HFP), and vinylidene fluoride (VDF). In some embodiments, the B block comprises 25-65 wt % VDF and 15-60 wt % HFP; or even 35-60 wt % VDF and 25-50 wt % HFP. Monomers, in addition, to those mentioned above, may be included in the A and/or B blocks. Generally, the weight average of the A block and B block are independently selected from at least 1000, 5000, 10000, or even 25000 daltons; and at most 400000, 600000, or even 800000 daltons. Such block copolymers are disclosed in WO 2017/013379 (Mitchell et al.); and U.S. Provisional Appl. Nos. 62/447675, 62/447636, and 62/447664, each filed 18 Jan. 2017; all of which are incorporated herein by reference.

Fluorinated elastomeric gums useful herein comprise cure sites, which act as reaction sites for crosslinking the fluoropolymer to form a fluoroelastomer. Typically, the fluorinated elastomeric gum comprises at least 0.05, 0.1, 0.5, 1, or even 2% by mole of cure sites and at most 5, or even 10% by mole of cure sites versus moles of fluorinated elastomeric gum.

In some embodiments, fluorinated elastomeric gums may be polymerized in the presence of a chain transfer agent and/or cure site monomers to introduce the cure sites into the fluorinated elastomeric gum.

Illustrative specific chain transfer agents can include, for example: an iodo-chain transfer agent, and a bromo-chain transfer agent. For example, suitable iodo-chain transfer agents in the polymerization include the formula of RI_{X}, where (i) R is a perfluoroalkyl or chloroperfluoroalkyl group having 3 to 12 carbon atoms; and (ii) x=1 or 2. The iodo-chain transfer agent may be a perfluorinated iodo-compound. Illustrative iodo-perfluoro-compounds include 1,3-diiodoperfluoropropane, 1,4-diiodoperfluorobutane, 1,6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof. In some embodiments, the bromine can be derived from a brominated chain transfer agent of the formula: RBr_{X}, where (i) R is a perfluoroalkyl or chloroperfluoroalkyl group having 3 to 12 carbon atoms; and (ii) x=1 or 2. The chain transfer agent may be a perfluorinated bromo-compound.

Cure-site monomers, if utilized, can comprise at least one of a bromine, iodine, and/or nitrile cure moiety.

In some embodiments, the cure site monomers may be derived from one or more compounds of the formula: (a) CX₂═CX(Z), wherein: (i) X each is independently H or F; and (ii) Z is I, Br, R_{f}—U wherein U═I or Br and R_{f}=a perfluorinated or partially perfluorinated alkylene group optionally containing O atoms; or (b) Y(CF₂)_{g}Y, wherein: (i) Y is Br or I or Cl and (ii) q=1-6. In addition, non-fluorinated bromo-or iodo-olefins, e.g., vinyl iodide and allyl iodide, can be used. In some embodiments, the cure site monomers are derived from compounds such as CH₂═CHI, CF₂═CHI, CF₂═CFI, CH₂═CHCH₂I, CF₂═CFCF₂I, ICF₂CF₂CF₂CF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, or combinations thereof.

In some embodiments, the cure site monomers comprise nitrile-containing cure moieties. Useful nitrile-containing cure site monomers include nitrile-containing fluorinated olefins and nitrile-containing fluorinated vinyl ethers, such as: perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN; CF₂═CFO[CF₂CF(CF₃)O]_{q}(CF₂)_{y}OCF(CF₃)CN wherein q is an integer from 0 to 4 and y is an integer from 0 to 6; CF₂═CF[OCF₂CF(CF₃)]ᵣO(CF₂)ₜCN wherein r is 1 or 2, and t is an integer from 1 to 4; and derivatives and combinations of the foregoing. Examples of a nitrile-containing cure site monomer include CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂CF(CF₃)OCF₂CF₂CN; and combinations thereof.

Peroxide

Disclosed compositions can also include a peroxide containing compound or a peroxide. The peroxide forms a covalent bond between the fluorinated elastomeric gum and the compound of formula I. Peroxide curatives include organic or inorganic peroxides. In some embodiments, organic peroxides can be utilized, particularly those that do not decompose during dynamic mixing temperatures.

In some embodiments, a tertiary butyl peroxide having a tertiary carbon atom attached to a peroxy oxygen can be utilized, for example.

Illustrative specific examples of organic peroxides include benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O ′-1,3-propanediyl OO,OO′-bis(1,1-dimethylethyl)ester, tert-butylperoxy benzoate, t-hexyl peroxy-2-ethylhexanoate, t-butyl peroxy-2-ethylhexanoate, di(4-methylbenzoyl)peroxide, laurel peroxide, cyclohexanone peroxide, and combinations thereof. Other suitable peroxide curatives are listed in U.S. Pat. No. 5,225,504 (Tatsu et al.), the disclosures of which is incorporated herein by reference.

The amount of peroxide used generally will be at least 0.1, 0.2, 0.4, 0.6, 0.8, 1, 1.2, or even 1.5; and at most 2, 2.25, 2.5, 2.75, 3, 3.5, 4, 4.5, 5, or even 5.5 parts by weight per 100 parts of the fluorinated elastomeric gum.

Additional Components in the Composition

A composition containing a fluorinated elastomeric gum may or may not be crosslinked. Crosslinking of the resulting composition can be performed using a cure system that is known in the art such as: a peroxide curative, 2,3-dimethyl-2,3-dimethyl-2,3-diphenyl butane, and other radical initiators such as azo compounds, and other cure systems such as a polyol and polyamine cure systems.

Peroxide curatives include organic or inorganic peroxides. In some embodiments, organic peroxides can be utilized, particularly those that do not decompose during dynamic mixing temperatures.

Crosslinking using a peroxide can be performed generally by using an organic peroxide as a crosslinking agent and, if desired, a crosslinking aid including, for example, bisolefins (such as CH₂═CH(CF₂)₆CH═CH₂, and CH₂═CH(CF₂)₈CH═CH₂), diallyl ether of glycerin, triallylphosphoric acid, diallyl adipate, diallylmelamine and triallyl isocyanurate (TAIC), fluorinated TAIC comprising a fluorinated olefinic bond, tri(methyl)allyl isocyanurate (TMAIC), tri(methyl)allyl cyanurate, poly-triallyl isocyanurate (poly-TAIC), xylylene-bis(diallyl isocyanurate) (XBD), and N,N′-m-phenylene bismaleimide.

Examples of azo compounds useful in curing a composition containing the fluorinated copolymers of the present disclosure are those that have a high decomposition temperature. In other words, they decompose above the upper use temperature of the resulting product. Such azo compounds may be found for example in “Polymeric Materials Encyclopedia, by J. C. Salamone, ed., CRC Press Inc., New York, (1996) Vol. 1, page 432-440.

The crosslinking using a polyamine is performed generally by using a polyamine compound as a crosslinking agent, and an oxide of a divalent metal such as magnesium, calcium, or zinc. Examples of the polyamine compound or the precursor of the polyamine compound include hexamethylenediamine and a carbamate thereof, 4,4′-bis(aminocyclohexyl)methane and a carbamate thereof, and N,N-dicinnamylidene-1,6-hexamethylenediamine.

The crosslinking agent (and crosslinking aid, if used) each may be used in conventionally known amounts, and the amounts used can be appropriately determined by one skilled in the art. The amount used of each of these components participating in the crosslinking may be, for example, about 1 part by mass or more, about 5 parts by mass or more, about 10 parts by mass or more, or about 15 parts by mass or more, and about 60 parts by mass or less, about 40 parts by mass or less, about 30 parts by mass or less, or about 20 parts by mass or less, per 100 parts by mass of the fluorinated copolymer. The total amount of the components participating in the crosslinking may be, for example, about 1 part by mass or more, about 5 parts by mass or more, or about 10 parts by mass or more, and about 60 parts by mass or less, about 40 parts by mass or less, or about 30 parts by mass or less, per 100 parts by mass of the fluorinated copolymer.

For the purpose of, for example, enhancing the strength or imparting the functionality, conventional adjuvants, such as, for example, acid acceptors, fillers, process aids, or colorants may be added to the composition.

For example, acid acceptors may be used to facilitate the cure and thermal stability of the composition. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof The acid acceptors can be used in amount raging from about 1 to about 20 parts per 100 parts by weight of the fluorinated copolymer.

Fillers can include, for example, an organic or inorganic filler such as clay, silica (SiO₂), alumina, iron red, talc, diatomaceous earth, barium sulfate, wollastonite (CaSiO₃), calcium carbonate (CaCO₃), calcium fluoride, titanium oxide, iron oxide and carbon black fillers, a polytetrafluoroethylene powder, PFA (TFE/perfluorovinyl ether copolymer) powder, an electrically conductive filler, a heat-dissipating filler, and the like may be added as an optional component to the composition. Those skilled in the art are capable of selecting specific fillers at required amounts to achieve desired physical characteristics in the vulcanized compound. The filler components may result in a compound that is capable of retaining a preferred elasticity and physical tensile, as indicated by an elongation and tensile strength value, while retaining desired properties such as retraction at lower temperature (TR-10). In some embodiments, the composition comprises less than 40, 30, 20, 15, or even 10% by weight of the filler.

Processing of the Composition

Compositions containing the functional fluorinated silane compound, the fluorinated elastomeric gum and other components can be mixed with the curing agent and optional conventional adjuvants. The method for mixing can include, for example, kneading with use of a twin roll for rubber, a pressure kneader or a Banbury mixer.

The mixture may then be processed and shaped such as by extrusion or molding to form an article of various shapes such as sheet, a hose, a hose lining, an o-ring, a gasket, a packer, or a seal composed of the composition of the present disclosure. The shaped article may then be heated to cure the gum composition and form a cured elastomeric article.

Pressing of the compounded mixture (i.e., press cure) is typically conducted at a temperature of about 120-220° C., or even about 140-200° C., for a period of about 1 minute to about 15 hours, usually for about 1-15 minutes. A pressure of about 700-20,000 kPa (kiloPascals), or even about 3400-6800 kPa, is typically used in molding the composition. The molds first may be coated with a release agent and prebaked.

The molded vulcanizate can be post cured in an oven at a temperature of about 140-240° C., or even at a temperature of about 160-230° C., for a period of about 1-24 hours or more, depending on the cross-sectional thickness of the sample. For thick sections, the temperature during the post cure is usually raised gradually from the lower limit of the range to the desired maximum temperature. The maximum temperature used is preferably about 260° C., and is held at this value for about 1 hour or more.

Cured Compositions

Disclosed compositions can be cured using any curing methods, including radiation induced curing, thermal curing, etc.

Disclosed compositions have been found to have good tensile strength, and 100% modulus. Surprisingly, it has also been discovered that the fluorinated block copolymer of the present disclosure has good compression set. Compression set is the deformation of the polymer remaining once a force is removed. Generally, lower compression set values are better (i.e., less deformation of the material). Typically, plastics (comprising a semicrystalline morphology) do not have good compression set. Therefore, it was surprising that the fluorinated block copolymer comprising the semicrystalline segment has good compression set. It was also surprising that the fluorinated block copolymers of the present disclosure retained their properties at elevated temperatures.

Articles

Disclosed compositions may be used in articles, such as a hose, a seal (e.g., a gasket, an o-ring, a packer element, a blow-out preventor, a valve, etc.), a stator, or a sheet. These compositions may or may not be post cured.

While particular implementations of compositions including functional fluorinated silane compounds are described herein, other configurations and embodiments consistent with and within the scope of the present disclosure will be apparent to one of skill in the art upon reading the present disclosure. Various modifications and alterations of the present disclosure will become apparent to those skilled in the art without departing from the scope and spirit of this invention.

### EXAMPLES

Objects and advantages may be further illustrated by the following examples, but the particular materials and amounts thereof recited in these examples, as well as other conditions and details, should not be construed to unduly limit this disclosure.

All materials are commercially available, for example from Sigma-Aldrich Chemical Company, Milwaukee, Wis., USA, or known to those skilled in the art, unless otherwise stated or apparent. Unless otherwise noted, all parts, percentages, ratios, etc. in the examples and the rest of the specification are by weight. The following abbreviations are used in this section: mL=milliliters, g=grams, lb=pounds, mm=millimeters, wt %=percent by weight, min=minutes, h=hours, NMR=nuclear magnetic resonance, ppm=parts per million, phr=parts per hundred rubber; ° C.=degrees Celsius, dNm=deci-newton-meter, mmHg=millimeters of mercury, kPa=kilopascal, mol=moles, psig=pounds per square inch gauge Abbreviations for materials used in this section, as well as descriptions of the materials, are provided in Table 1.

TABLE 1

| Material | Details |
|---|---|
| Polymer | A fluorinated block copolymer that can be prepared |
| | as described for “Polymer 3” in PCT App. |
| | WO2017/01137 |
| N990 | Carbon black, available under the trade designation |
| | “N990” from Cancarb Ltd, Medicine Hat, Alta., |
| | Canada |
| TAIC | Triallyl-isocyanurate, a co-agent, available under |
| | the trade designation “TAIC” from Nippon Kasei |
| | Chemical Co. Ltd., Tokyo, Japan |
| Peroxide | 2,5-dimethyl-2,5-di(t-butylperoxy)-hexane, 50% |
| | active, available under the trade designation |
| | “VAROX DBPH-50” from Vanderbilt Chemicals, |
| | LLC., Norwalk, CT. |
| AS | 7-Octenyltrimethoxysilane, a Co-agent, available |
| | from Gelest Inc., Morrisville, PA, USA |
| IC₄F₈I | 1,4-Diiodoperfluorobutane, available from Tosoh, |
| | Grove City, OH, USA |
| Sodium | 25 wt % solution in methanol, available from |
| methoxide | Sigma Aldrich |
| Allyl acetate | Available from Alfa Aesar, Ward Hill, MA, USA |
| t-Butylperoxy-2- | Available from United Initiators, Elyria, OH, USA |
| ethylhexanoate | |
| t-Amylperoxy-2- | Available from United Initiators |
| ethylhexanoate | |
| Ethylene | Available from Sigma Aldrich |
| Methanol | Available from Sigma Aldrich |
| KF | Available from Sigma Aldrich |
| Tetra-n- | Available from Alfa Aesar |
| butylammonium | |
| bromide | |
| Allyl bromide | Available from TCI America, Portland, OR, USA |
| Diglyme | Available from Sigma Aldrich |
| Perfluorosuccinyl | Available from Exfluor Research Corp, Austin, |
| fluoride | TX, USA |
| Zinc Powder | Available from Sigma Aldrich |
| Bromine | Available from Sigma Aldrich |
| Trichlorosilane | Available from Sigma Aldrich |
| Platinum divinyl | 2.2% Pt solution in xylene, available from Gelest |
| tetramethyl | |
| disiloxane | |
| complex | |

Characterization Methods

Melting Point Measurement and Glass Transition

Melting point (Tₘ) and glass transition temperature (T_{g}) were determined in accordance with ASTM D 793-01 and ASTM E 1356-98 under a nitrogen flow using a differential scanning calorimeter available under the trade designation “DSC Q2000” from TA Instruments, New Castle, Del., USA. A DSC scan was obtained from −80° C. to 325° C. at 10° C./min scan rate.

Cure Rheology

Cure rheology tests were carried out using uncured, compounded samples using a rheometer available under the trade designation “PPA 2000” from Alpha technologies, Akron, Ohio, in accordance with ASTM D 5289-93a at 177° C., no pre-heat, 12 min elapsed time, and a 0.5 degree arc. Both the minimum torque (M_{L}) and highest torque attained during a specified period of time when no plateau or maximum torque (M_{H}) was obtained were measured., the time for the torque to reach a value equal to M_{L}+0.1(M_{H}−M_{L}), (t′10), the time for the torque to reach a value equal to M_{L}+0.5(M_{H}−M_{L}), (t′50), and the time for the torque to reach M_{L}+0.9(M_{H}−M_{L}), (t′90). Results are presented in Table 3.

Tensile and Tear C

Tensile data was gathered from post cured samples cut to Die D specifications at room temperature in accordance with ASTM 412-06a. Tensile data at elevated temperature was measured on Die D dumbbells. Tear C data was gathered on post cured sheets in accordance with ASTM D624. Results are presented in Tables 4 through 6.

Molding O-Rings and Compression Set

O-rings (214, AMS AS568) were molded at 177° C. for 10 min. The press cured O-rings were post-cured at 232° C. for 4 h. The press cured and post cured O-rings were tested for compression set for 70 h at 200° C. in accordance with ASTM D 395-03 Method B and ASTM D 1414-94 with 25% initial deflection. Results are reported as percentages. The test results are presented in Table 7.

Preparation of Functional Fluorinated Silane Compounds

CH₂═CHCH₂C₄F₈CH₂CH₂CH₂Si(OCH₃)₃, AC4PTMS: To a 1 L, 3-neck round bottom flask equipped with a mechanical stirrer, thermocouple and condenser was charged 454 g (1.0 mol) of IC₄F₈I, 300 g (3.0 mol) of allyl acetate and 4 g (0.018 mol) of t-butylperoxy-2-ethylhexanoate. The mixture was stirred and heated to 75° C. for 20 h. The red-brown solution was vacuum stripped to remove starting allyl acetate and added dropwise to a 1 L, 3-neck round bottom flask equipped with a mechanical stirrer, thermocouple and condenser that was charged with 125 g (1.9 mol) of zinc powder, 400 g methanol that was activated with 10 g (0.06 mol) of bromine. The mixture was allowed to reflux at 65° C. for 1 h and distilled over into a receiver containing water to isolate 105 g (0.37 mol) of diallyl octafluorobutane. To a 250 mL, round bottom flask equipped with a mechanical stirrer, thermocouple and condenser was charged 105 g (0.37 mol) of diallyl octafluorobutane, 20g (0.15 mol) of trichlorosilane and 300 ppm platinum divinyl tetramethyl disiloxane complexstirred and heated to 60° C. for 4 h. The solution was vacuum stripped to first remove excess diallyl octafluorobutane, isolating 78 g (0.19 mol) of CH₂═CHCH₂C₄F₈CH₂CH₂CH₂SiCl₃ having a boiling point of 66° C. at 5 Torr for a 73% yield. NMR confirmed the compound.

To a 250 mL 3-neck, round bottom flask containing a magnetic stir bar, thermocouple and condenser was charged 25 g methanol. The methanol was stirred and 45 g (0.11 mol) of CH₂═CHCH₂C₄F₈CH₂CH₂CH₂SiCl₃ was added dropwise. The reaction was stirred at 30° C. for 15 min and vacuum distillation isolated 38 g (0.09 mol) of CH₂═CHCH₂C₄F₈CH₂CH₂CH₂—Si(OCH₃)₃ having a boiling point of 95° C. at 2 Torr for an 87% yield. NMR confirmed the compound.

CH₂═CHCH₂—O—C₄F₈—O—CH₂CH₂CH₂Si(OCH₃)₃, AEC4EPTMS: To a 600 mL stirred reactor, available from Parr Instrument Company, was charged 100 g (1.7 mol) KF, 12 g (0.04 mol) tetra-n-butylammonium bromide, and 250 g diglyme. The reactor was sealed and placed under 25 Torr of vacuum. To the reactor was charged 121 g (1.0 mol) allylbromide, available from TCI, and 70 g (0.36 mol) perfluorosuccinyl fluoride, after the reactor was cooled to 6° C. The contents of the reactor were stirred and heated to 75° C. for 20 h. The reactor was cooled to 25° C. and the contents were washed three times each with 400 g distilled water. Distillation of the lower fluorochemical phase gave 67 g (0.21 mol) octafluorobutane diallyl ether, CH₂═CHCH₂—O—C₄F₈—O—CH₂CH═CH₂, with a boiling point of 35° C. at 3 Torr for a 59% yield. Two additional runs were carried out and the products of the three runs were combined to yield a total of 200 g of octafluorobutane diallyl ether. In a 250 mL round bottom flask equipped with a stir bar was added 160 g (0.51 mol) octafluorobutane diallyl ether and 28 g (0.21 mol) of trichlorosilane, and 300 ppm platinum divinyl tetramethyl disiloxane complex. The contents were stirred and heated to 63° C. for 2 h. The solution was vacuum stripped to first remove excess octafluorobutane diallyl ether, resulting in isolation of 77 g (0.17 mol) of CH₂═CHCH₂—O—C₄F₈—O—CH₂CH₂CH₂SiCl₃, having a boiling point of 92° C. at 3 Torr for a 82% yield. NMR confirmed the compound. To a 250 mL 3-neck, round bottom flask containing a magnetic stir bar, thermocouple and condenser was charged 20 g methanol. The methanol was stirred and 22 g (0.05 mol) of CH₂═CHCH₂—O—C₄F₈—O—CH₂CH₂CH₂SiCl₃was added dropwise. The reaction was stirred at 30° C. for 15 min and vacuum distillation isolated 18 g, (0.04 mol) of CH₂═CHCH₂—O—C₄F₈—O—CH₂CH₂CH₂Si(OCH₃)₃ having a boiling point of 82° C. at 3 Torr for an 86% yield. NMR confirmed the compound.

Preparation of CH₂═CHC₄F₈CH₂CH₂Si(OCH₃)₃, VC4ETMS: To a 600 mL stirred reactor, available from Parr Instrument Company, Moline, Ill., USA, was charged 500 g (1.1 mol) of IC₄F₈I, 17 g (0.07 mol) of t-amylperoxy-2-ethylhexanoate stirred and heated to 60° C. Ethylene was charged to 20 psig (139 kPa) over 1 h adding 28 g (1 mol) of ethylene. The reactor was cooled to 25° C. and 518 g mixture containing 16 mol % of IC₂H₄C₄F₈C₂H₄I was isolated. The product of five runs was combined. Distillation gave 510 g pot bottoms having a boiling point greater than 100° C. at 7 Torr as mostly IC₂H₄C₄F₈C₂H₄I. To a 2 L 3-neck, round bottom flask equipped with a mechanical stirrer, thermocouple and condenser 510 g (1.0 mol) of IC₂H₄C₄F₈C₂H₄I, 500 g methanol was charged and stirred. A charge of 540 g, (2.5 mol) of sodium methoxide as a 25 wt % solution was added over 1 h at 36° C. The mixture was allowed to reflux at 65° C. for 1 h and distilled over into a receiver containing water to isolate 81 g (0.31 mol) of CH₂═CHC₄F₈CH═CH₂. In a pressure glass tube containing a magnetic stir bar was charged 81 g (0.32 mol) CH₂═CHC₄F₈CH═CH₂ and 14 g (0.10 mol) trichlorosilane, ten drops of Platinum divinyl tetramethyl disiloxane complex was added sealed and heated to 125° C. for 3 h. The solution was vacuum stripped to first remove excess divinyl octafluorobutane isolated 25 g (0.06 mol) of CH₂═CHC₄F₈CH₂CH₂SiCl₃ having a boiling point of 88° C. at 6 Torr for a 62% yield. NMR confirmed the compound. To a 250 mL 3-neck, round bottom flask containing a magnetic stir bar, thermocouple and condenser was charged 12 g methanol. The methanol was stirred and 25 g (0.06 mol) of CH₂═CHC₄F₈CH₂CH₂SiCl₃ was added dropwise. The reaction was stirred at 30° C. for 15 min and vacuum distillation isolated 19.3g (0.05 mol) of CH₂═CHC₄F₈CH₂CH₂Si(OCH₃)₃ having a boiling point of 66° C. at 2 Torr for an 80% yield. ¹⁹FNMR negative upfield of internal CFCl₃, ¹HNMR ppm downfield of internal TMS and ²⁹SiNMR negative ppm upfield of internal TMS in CDCl₃. CH^{a}H^{b}═CH^{c}CF₂^{d}CF₂^{e}CF₂^{f}CF₂^{g}CH₂^{h}CH₂ⁱSi^{j}(OCH₃k)₃, (a) 5.95 d/m, (b) 5.76 d/m (10.0 Hz d), (c) 5.96 d/t/d (10.0 Hz d), (d) −114.3 d/t, (e) −123.5 m, (f) −124.1 m, (g) −117.2 m (18.1 Hz m), (h) 2,12 t/t (18.1 Hz t), (i) 0.86 m, (j) −44.0, (k) 3.58 s.

### Examples 1 Through 3 (EX-1 Through EX-3) and Counter Examples 1 and 2 (CE-1 and CE-2)

For EX-1 through EX-3, 200 g polymer batches were compounded with the amounts of materials as listed in Table 2 on a two-roll mill, with Functional Fluorinated Silane Compounds as the CoAgent as indicated in Table 3. For CE-1, no Functional Fluorinated Silane Compound was used. For CE-2, the procedure described for EX-1 was followed, but with the exception that 7-Octenyltrimethoxysilane was utilized as the CoAgent. Samples were tested for cure rheology, tensile strength, Tear C, and compression set according to the procedures described above. The results are presented in Tables 3 through 7.

TABLE 2
Composition formulation

| Component | (phr) |
|---|---|
| Polymer | 100 |
| N990 | 30 |
| TAIC | 3 |
| Peroxide | 2 |
| CoAgent | 3 |

TABLE 3
Cure Rheology Results

| | Example or Counter Example Number | | | | |
|---|---|---|---|---|---|
| | CE-1 | EX-1 | EX-2 | EX-3 | CE-2 |
| CoAgent | None | AC4PTMS | VC4ETMS | AEC4EPTMS | AS |
| M_{L}, Minimum | 0.52 | 0.46 | 0.60 | 0.59 | 0.61 |
| Torque, Nm | | | | | |
| M_{H}, Maximum | 5.98 | 4.93 | 5.07 | 5.04 | 4.05 |
| Torque, Nm | | | | | |
| Δ torque, Nm | 5.46 | 4.46 | 4.47 | 4.45 | 3.44 |
| t′50, Time to | 0.7 | NA | 1.1 | 0.8 | 1.1 |
| 50% cure-min | | | | | |
| t′90, Time to | 1.2 | NA | 3.1 | 2.0 | 3.0 |
| 90% cure-min | | | | | |
| tan δ M_{L} | 1.49 | 0.99 | 0.48 | 0.55 | 0.46 |
| tan δ M_{H} | 0.077 | 0.109 | 0.09 | 0.085 | 0.126 |

TABLE 4
Tensile Strength at Room Temperature after 4 h cure at 232° C. (450° F.)

| | Example or Counter Example Number | | | | |
|---|---|---|---|---|---|
| | CE-1 | EX-1 | EX-2 | EX-3 | CE-2 |
| CoAgent | None | AC4PTMS | VC4ETMS | AEC4EPTMS | AS |
| Tensile, MPa | 28.8 | 34.5 | 35.7 | 32.5 | 26.0 |
| Elongation at | 140 | 157 | 137 | 123 | 122 |
| break, % | | | | | |
| Stress at 100% | 19.8 | 23.5 | 26.8 | 26.4 | 21.1 |
| strain, MPa | | | | | |
| Hardness, | 94 | 90 | 91 | 95 | 94 |
| Shore A | | | | | |

TABLE 5
Tensile Strength At 200° C.

| | Example or Counter Example Number | | | | |
|---|---|---|---|---|---|
| | CE-1 | EX-1 | EX-2 | EX-3 | CE-2 |
| CoAgent | None | AC4PTMS | VC4ETMS | AEC4EPTMS | AS |
| Tensile, MPa | 6.6 | 6.0 | 6.6 | 7.1 | 5.6 |
| Elongation at | 133 | 120 | 114 | 122 | 124 |
| break, % | | | | | |
| Stress at 100% | 4.9 | 4.9 | 5.5 | 5.5 | 4.3 |
| strain, MPa | | | | | |

TABLE 6
Tear C

| | Example or Counter Example Number | | | | |
|---|---|---|---|---|---|
| | CE-1 | EX-1 | EX-2 | EX-3 | CE-2 |
| CoAgent | None | AC4PTMS | VC4ETMS | AEC4EPTMS | AS |
| 23° C. Die C | 51 | 53 | 60 | 59 | 55 |
| Tear Strength, | | | | | |
| kN/m | | | | | |

TABLE 7
Compression Set, post cure, 70 h at 200° C.

| | Example or Counter Example Number | | | | |
|---|---|---|---|---|---|
| | CE-1 | EX-1 | EX-2 | EX-3 | CE-2 |
| Second Co-Agent | None | AC4PTMS | VC4ETMS | AEC4EPTMS | AS |
| post cure | 45 | 53 | 55 | 59 | 75 |

Thus, embodiments of compositions including functional fluorinated silane compounds are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. A curable composition comprising:
at least one fluorinated elastomeric gum; and
at least one functional fluorinated silane compound according to formula I:
X—(CF₂)ₙ—(O)ₚ—(CH₂)ₘ—Si—Y₃ (I)
wherein X is Br, I, CF₂═CF—O—, CH₂═CHCH₂—O—, CH₂═CH—, or CH₂═CHCH₂—,
n is an integer from 2 to 8,
m is an integer from 2 to 5,
p is 0 or 1, and
Y is Cl—or —OR, where R is a linear or branched alkyl having 1 to 4 carbon atoms.

2. The curable composition according to claim 1, wherein Y is —O(CH₂)ₓCH₃, wherein x is 0 to 3.

3. The curable composition according to claim 1, wherein the fluorinated elastomeric gum comprises at least 0.05% by weight of a cure site and at most 5% by weight of the cure-site.

4. The curable composition according to claim 3, wherein the cure site comprises at least one of bromine, iodine, nitrile, or combinations thereof.

5. The curable composition of claim 1, wherein the fluorinated elastomeric gum is partially fluorinated.

6. The curable composition of claim 1, wherein the fluorinated elastomeric gum is derived from at least one of TFE, HFP, VDF, a fluorinated vinyl ether monomer, a fluorinated allyl ether monomer, or combinations thereof

7. The curable composition of claim 1, wherein the fluorinated elastomeric gum comprises at least one of: (i) copolymers comprising TFE and a perfluoroalkyl vinyl ether monomeric units; (ii) copolymers comprising TFE and a perfluoroalkoxy vinyl ether monomeric units; (iii) copolymers comprising TFE and propylene monomeric units; (iv) copolymers comprising TFE, propylene, and VDF monomeric units; (v) copolymers comprising VDF and HFP monomeric units; (vi) copolymers comprising TFE, VDF, and HFP monomeric units; (vii) copolymers comprising VDF and perfluoroalkyl vinyl ether monomeric units; (viii) copolymers comprising CTFE and VDF monomeric units; (ix) copolymers comprising TFE and VDF monomeric units; (x) copolymers comprising TFE, VDF and perfluoroalkyl vinyl ether monomeric units; and (xi) combinations thereof.

8. The curable composition of claim 1, wherein the fluorinated elastomeric gum is a block copolymer comprising at least one A block and at least one B block.

9. The curable composition of claim 8, wherein the A block comprises 30-85 wt % TFE; 5-40 wt % HFP; and 5-55 wt % VDF; and the B block comprises 25-65 wt % VDF and 15-60 wt % HFP; or even 35-60 wt % VDF and 25-50 wt % HFP based on the weight of the fluorinated elastomeric gum.

10. The curable composition of claim 1, comprising at least 0.1 to at most 30 parts by weight of the functional fluorinated silane compound of formula I per 100 parts by weight of the fluorinated elastomeric gum.

11. (canceled)

12. The curable composition of claim 1, further comprising a peroxide.

13. The curable composition of claim 12, wherein the peroxide comprises at least one of benzoyl peroxide, dichlorobenzoyl peroxide, dicumyl peroxide, 2,5-dimethyl-2,5-di(t-butylperoxy)hexane, di-t-butyl peroxide, t-butylperoxy benzoate, 2,5-dimethyl-2,5-di(t-butylperoxy)hexane-3, laurel peroxide, or combinations thereof.

14. The curable composition of claim 12, further comprising a non-fluorinated, polyunsaturated compound, wherein the non-fluorinated polyunsaturated compound comprises at least one of: tri(methyl)allyl isocyanurate, triallyl isocyanurate, tri(methyl)allyl cyanurate, poly-triallyl isocyanurate; or combinations thereof.

15. The curable composition of claim 1, wherein n is an integer from 2 to 4.

16. The curable composition of claim 1, wherein m is an integer from 2 to 3.

17. The curable composition of claim 1, wherein Y is —OCH₃.

18. The curable composition of claim 1, wherein the functional fluorinated silane compound is selected from:
Br—C₂F₄—CH₂CH₂—SiCl₃ (BTFETCS), and
Br—C₂F₄—CH₂CH₂—Si(OCH₃)₃ (BTFETMS).

19. The curable composition of claim 1, wherein the functional fluorinated silane compound is selected from
CF₂═CF—O—C₄F₈—CH₂CH₂—SiCl₃ (MV4ETCS),
CF₂═CF—O—C₄F₈—CH₂CH₂—Si(OCH₃)₃ (MV4ETMS),
CF₂═CF—O—C₄F₈—CH₂CH₂CH₂—SiCl₃ (MV4PTCS), and
CF₂═CF—O—C₄F₈—CH₂CH₂CH₂—Si(OCH₃)₃ (MV4PTMS).

20. The curable composition of claim 1, wherein the functional fluorinated silane compound is selected from
CH₂═CHCH₂C₄F₈CH₂CH₂CH₂SiCl₃ (AC4PTCS), and
CH₂═CHCH₂C₄F₈CH₂CH₂CH₂Si(OCH₃)₃ (AC4PTMS).

21. The curable composition of claim 1, wherein the functional fluorinated silane compound is selected from
CH₂═CHCH₂—O—C₄F₈—O—CH₂CH₂CH₂SiCl₃ (AEC4EPTCS), and
CH₂═CHCH₂—O—C₄F₈—O—CH₂CH₂CH₂Si(OCH₃)₃ (AEC4EPTMS).

22. The curable composition of claim 1, wherein the functional fluorinated silane compound is selected from
CH₂═CHC₄F₈CH₂CH₂SiCl₃ (VC4ETCS), and
CH₂═CHC₄F₈CH₂CH₂Si(OCH₃)₃ (VC4ETMS).

23. A cured article comprising a cured curable composition according to claim 1.

24. The article according to claim 23, wherein the cured article is a molded part, a hose, a gasket, or a seal.
